(19) United States
(12) Patent Application Publication
(10) Pub. No.: US 2002/0161941 A1
(43) Pub. Date: Oct. 31, 2002

(54) System and method for efficiently performing a data transfer operation

(75) Inventors: Harry Chue, Alameda, CA (US); Delmar Marr, San Jose, CA (US); James A. Chee, San Ramon, CA (US); Praveen K. Kolli, Sunnyvale, CA (US)

Correspondence Address: Gregory J. Koerner, SIMON & KOERNER LLP, Suite B, 10052 Pasadena Avenue, Cupertino, CA, 95014, US

(73) Assignee: Sony Corporation and Electronics, Inc

(21) Appl. No.: 09/846,906

(22) Filed: Apr. 30, 2001

(51) Int. Cl. G06F 13/28

(52) U.S. Cl. 710/22

(57) ABSTRACT

A system and method for efficiently performing a data transfer operation in an electronic system preferably includes a processor that may initially create a DMA structure in a block transfer memory device. The DMA structure may preferably include one or more command structures for performing DMA data transfer operations. The processor may subsequently program local control registers of a DMA engine with selected DMA transfer information in response to a DMA data transfer requirement. The processor may then instruct the DMA engine to perform the required DMA data transfer operation. Next, the DMA engine may responsively copy one or more of the command structures from the block transfer memory device into local command registers that are coupled to the DMA engine. The DMA engine may then reference the foregoing control registers and command registers to thereby efficiently perform one or more DMA data transfer operations.

### BACKGROUND SECTION

1. Field of the Invention

This invention relates generally to techniques for managing data, and relates more particularly to a system and method for efficiently performing a data transfer operation.

2. Description of the Background Art

Implementing efficient methods for transferring data is a significant consideration for designers and manufacturers of contemporary electronic devices. However, efficiently transferring data with electronic devices may create substantial challenges for system designers. For example, enhanced demands for increased device functionality and performance may require more system processing power and require additional hardware resources. An increase in processing or hardware requirements may also result in a corresponding detrimental economic impact due to increased production costs and operational inefficiencies.

Furthermore, enhanced device capability to perform various advanced transfer operations may provide additional benefits to a system user, but may also place increased demands on the control and management of various device components. For example, an enhanced electronic device that transfers digital image data may benefit from an effective implementation because of the large amount and complexity of the digital data involved.

In certain contemporary environments, complex or lengthy data transfer operations may often consume substantial amounts of available system resources to the detriment of other system functionalities. For example, a system central processing unit may be diverted from other important tasks if frequently required to coordinate and control one or more data transfer operations of significant complexity or length.

Due to growing demands on system resources and substantially increasing data magnitudes, it is apparent that developing new techniques for transferring data is a matter of concern for related electronic technologies. Therefore, for all the foregoing reasons, developing efficient systems for transferring data remains a significant consideration for designers, manufacturers, and users of contemporary electronic devices.

### SUMMARY

In accordance with the present invention, a system and method are disclosed for efficiently performing a data transfer operation in an electronic system. In one embodiment, initially, a central processing unit (CPU) may preferably create a direct memory access (DMA) structure that includes one or more command structures. The CPU may preferably store the resultant DMA structure into a block-transfer memory device that is coupled to the electronic system.

Then, the CPU may preferably monitor the electronic system until performance of a DMA transfer operation is required by any appropriate entity. When a DMA transfer operation is required by the electronic system, then the CPU may selectively program one or more local control registers of a DMA engine to provide relevant information regarding the required DMA transfer operation for local access by a DMA engine of the electronic system.

Next, the CPU may preferably instruct the DMA engine to assume control and perform the required DMA operation. In certain embodiments, the CPU may set a start bit in a DMA start register of the local control registers to thereby instruct the DMA engine to perform the required DMA operation. The CPU may then advantageously begin to perform other processing tasks for the electronic system.

In response, a state machine of the DMA engine may preferably copy a designated command structure from the block-transfer memory device into local command registers that are coupled to the DMA engine. The DMA engine may then preferably reference transfer information in the foregoing control registers and command registers to efficiently perform the required DMA transfer operation. The DMA engine may preferably also monitor the DMA transfer operation to determine whether a stop condition has occurred. If the DMA engine determines that a stop condition has occurred with regard to the current DMA transfer operation, then the DMA engine may preferably notify the CPU that a stop condition has occurred, and the DMA engine may then terminate the current DMA data transfer operation.

In accordance with the present invention, the foregoing procedure permits an electronic system to efficiently perform DMA data transfer operations without repeatedly accessing the block transfer memory device to obtain relatively small amounts of data. Such block transfer accesses may become excessively inefficient due to a corresponding consumption of data transfer resources of the electronic system. The present invention therefore provides a technique for efficiently avoiding block transfer penalties and related operational inefficiencies during a DMA data transfer operation. The present invention thus provides an improved system and method for efficiently performing a data transfer operation.

### BRIEF DESCRIPTION OF THE DRAWINGS

FIG. 1 is a block diagram for one embodiment of an electronic system, in accordance with the present invention;

FIG. 2 is a block diagram for one embodiment of the bridge device of FIG. 1, in accordance with the present invention;

FIG. 3 is a block diagram for one embodiment of the memory of FIG. 1, in accordance with the present invention;

FIG. 4 is an exemplary timing diagram for one embodiment of a block data transfer operation;

FIG. 5 is a block diagram for one embodiment of the DMA structure of FIG. 3, in accordance with the present invention;

FIG. 6 is a block diagram for one embodiment of a command structure from FIG. 5, in accordance with the present invention;

FIG. 7 is a block diagram of the DMA engine of FIG. 2, in accordance with one embodiment of the present invention;

FIG. 8 is a block diagram for one embodiment of the control registers of FIG. 7, in accordance with the present invention;

FIG. 9 is a block diagram illustrating a data transfer operation, in accordance with one embodiment of the present invention; and

FIG. 10 is a flowchart of method steps for performing a data transfer operation, in accordance with one embodiment of the present invention.

### DETAILED DESCRIPTION

The present invention relates to an improvement in data transfer techniques. The following description is presented to enable one of ordinary skill in the art to make and use the invention and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for efficiently performing a data transfer operation in an electronic system, and preferably includes a processor that may initially create a DMA structure in a block-transfer memory device. The DMA structure may preferably include one or more command structures for performing DMA data transfer operations. The processor may subsequently program various local control registers of a DMA engine with selected DMA transfer information in response to a DMA data transfer requirement. The processor may then instruct the DMA engine to perform the required DMA data transfer operation. Next, the DMA engine may responsively copy one or more of the command structures from the block-transfer memory device into local command registers that are coupled to the DMA engine. The DMA engine may then advantageously reference the foregoing control registers and command registers to thereby efficiently perform one or more DMA data transfer operations.

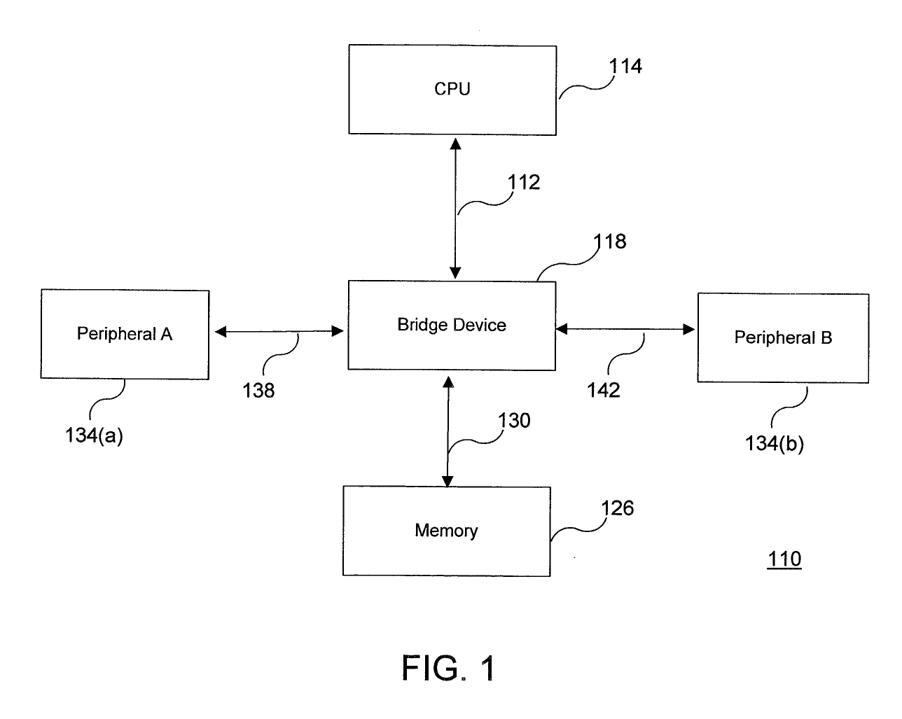

Referring now to FIG. 1, a block diagram for one embodiment of an electronic system 110 is shown, in accordance with the present invention. In the FIG. 1 embodiment, electronic system 110 may preferably include, but is not limited to, a central processing unit (CPU) 114, a bridge device 118, a memory 126, a peripheral A 134(a), and a peripheral B 134(b). In alternate embodiments, electronic system 110 may readily include various other elements or functionalities in addition to, or instead of, those elements or functionalities discussed in conjunction with the FIG. 1 embodiment. Furthermore, electronic system 110 may be implemented and configured in any desired manner. For example, electronic system 110 may be implemented as one or more integrated circuit devices, as a audio/visual electronic device, as a consumer electronics device, as a portable electronic device, or as a computer device.

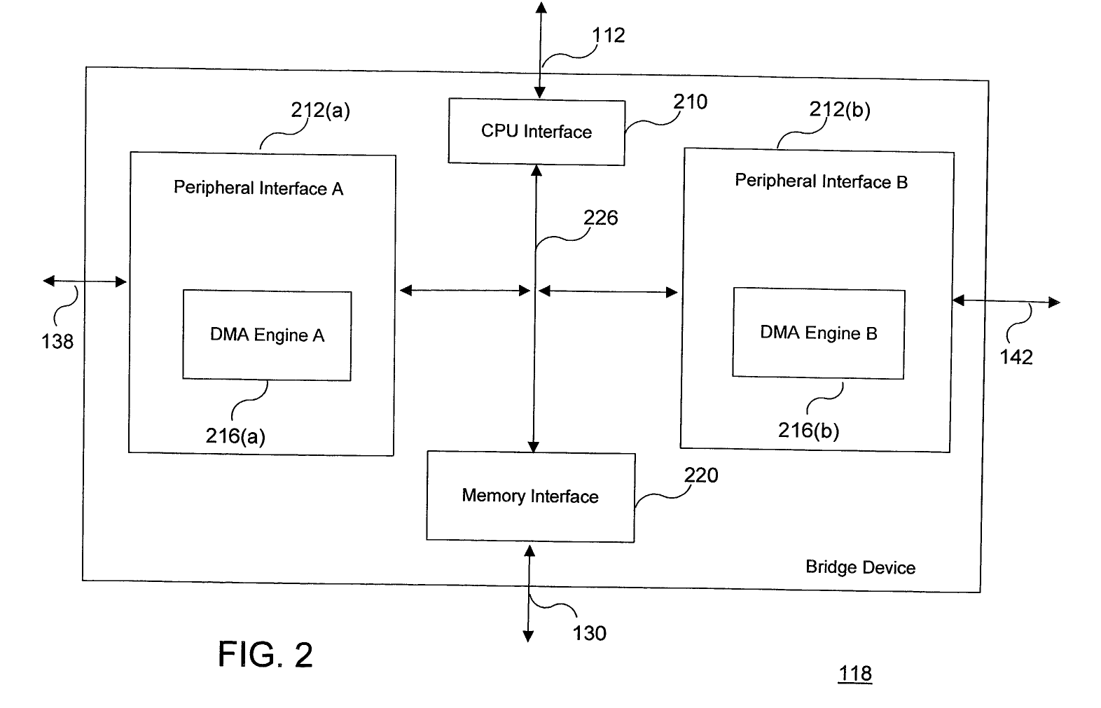

In the FIG. 1 embodiment, CPU 114 may preferably be implemented as any appropriate and effective processor device or microprocessor to thereby control and coordinate the operation of electronic system 110 in response to various software program instructions. Bridge device 118 may communicate with CPU 114 via path 112, and may preferably include one or more interfaces for bidirectionally communicating with other devices or entities in electronic system 110. One embodiment of bridge device 118 is further discussed below in conjunction with FIG. 2.

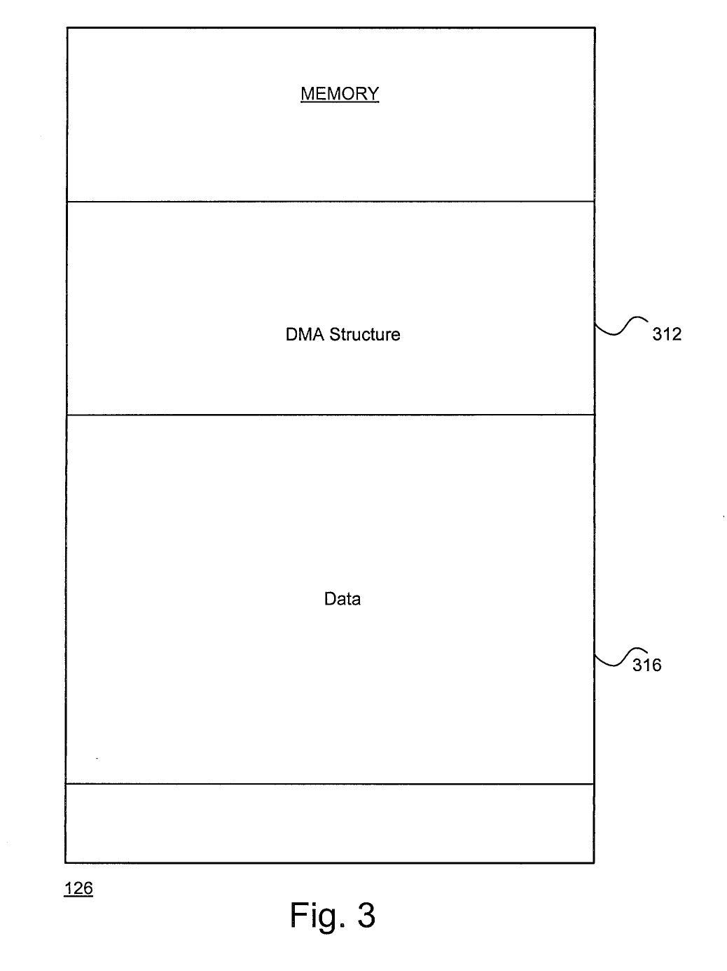

In the FIG. 1 embodiment, memory 126 may bidirectionally communicate with bridge device 118 via path 130. Memory 126 may be implemented by utilizing any desired technologies or configurations. For example, in certain embodiments, memory 126 may preferably be implemented as a memory device that is optimized for performing block transfers of various data. One implementation and configuration for memory 126 is further discussed below in conjunction with FIG. 3.

In accordance with the present invention, bridge device 118 may also bidirectionally communicate with various peripheral devices in electronic system 110. In the FIG. 1 embodiment, bridge device 118 may preferably communicate with a peripheral A 134(a) via path 138, and may also preferably communicate with a peripheral B 134(b) via path 142. In alternate embodiments, bridge device 118 may readily communicate with any desired number of peripheral devices in addition to, or instead of, those peripheral devices 134 that are presented and discussed in conjunction with the FIG. 1 embodiment.

Referring now to FIG. 2, a block diagram for one embodiment of the FIG. 1 bridge device 118 is shown, in accordance with the present invention. In the FIG. 2 embodiment, bridge device 118 may preferably include, but is not limited to, a CPU interface 210, a peripheral interface A 212(a), a peripheral interface B 212(b), a DMA engine A 216(a), a DMA engine B 216(b), and a memory interface 220. In alternate embodiments, bridge device 118 may readily include various other elements or functionalities in addition to, or instead of, those elements or functionalities discussed in conjunction with the FIG. 2 embodiment. In addition, bridge device 118 may be implemented in any appropriate manner. For example, in certain embodiments, bridge device 118 may be implemented as a separate integrated circuit device in electronic system 110.

In the FIG. 2 embodiment, CPU 114 may communicate with bridge device 118 through a CPU interface 210. Similarly, memory 126 may communicate with bridge device 118 through a memory interface 220. In addition, peripheral A 134(a) may communicate with bridge device 118 through a peripheral interface A 212(a), and peripheral B 134(b) may communicate with bridge device 118 through a peripheral interface B 212(b). Bridge device 118 may preferably also include a bridge bus 226 to enable various components and devices in electronic system 110 to effectively communicate through bridge device 118.

In the FIG. 2 embodiment, peripheral interface A 212(a) may preferably be associated with a DMA engine A 216(a) for performing a direct memory access (DMA) data transfer operation between peripheral A 134(a) and memory 126. Similarly, peripheral interface B 212(b) may preferably be associated with a DMA engine B 216(b) for performing a DMA data transfer operation between peripheral B 134(b) and memory 126. In the FIG. 2 embodiment, the two DMA engines 216 are shown as being integral with respective peripheral interfaces 212. However, in alternate embodiments, the DMA engines 216 of bridge device 118 may be implemented in any suitable location or manner. The configuration and functionality of DMA engines 216 are further discussed below in conjunction with FIGS. 3 through 10.

Referring now to FIG. 3, a block diagram for one embodiment of the FIG. 1 memory 126 is shown, in accordance with the present invention. In the FIG. 3 embodiment, memory 126 may preferably include, but is not limited to, a DMA structure 312 and data 316. In alternate embodiments, memory 126 may readily include various other elements or functionalities in addition to, or instead of, those elements or functionalities discussed in conjunction with the FIG. 3 embodiment.

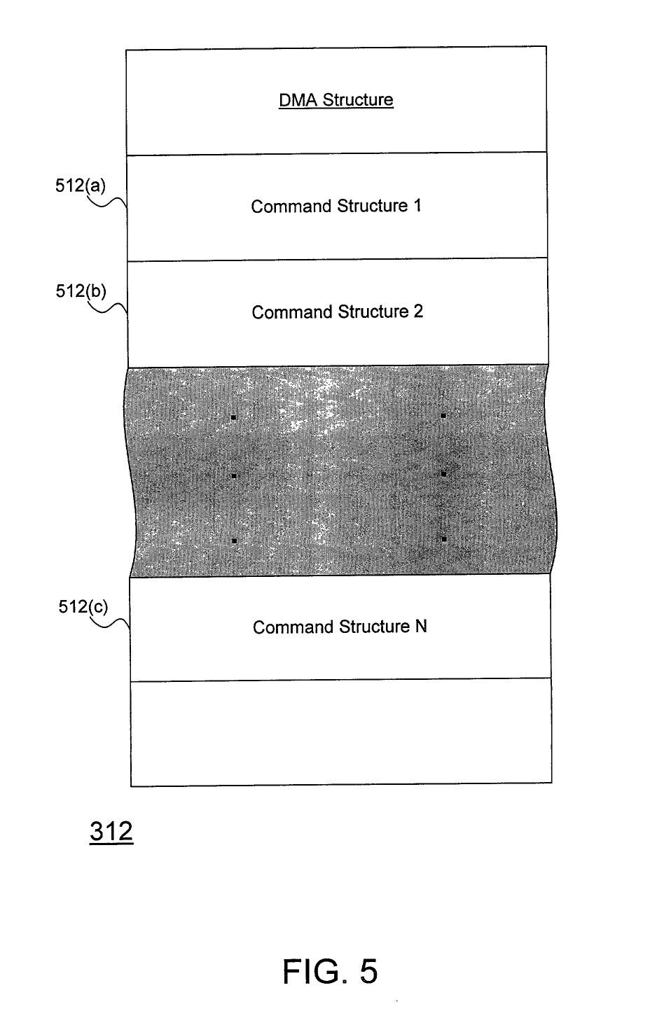

In the FIG. 3 embodiment, DMA structure 312 may preferably include various types of appropriate information for performing one or more DMA data transfer operations in electronic system 110. One embodiment for DMA structure 312 is further discussed below in conjunction with FIG. 5. In the FIG. 3 embodiment, data 316 may preferably include any desired type of information that is stored by memory 126 for use by electronic system 110.

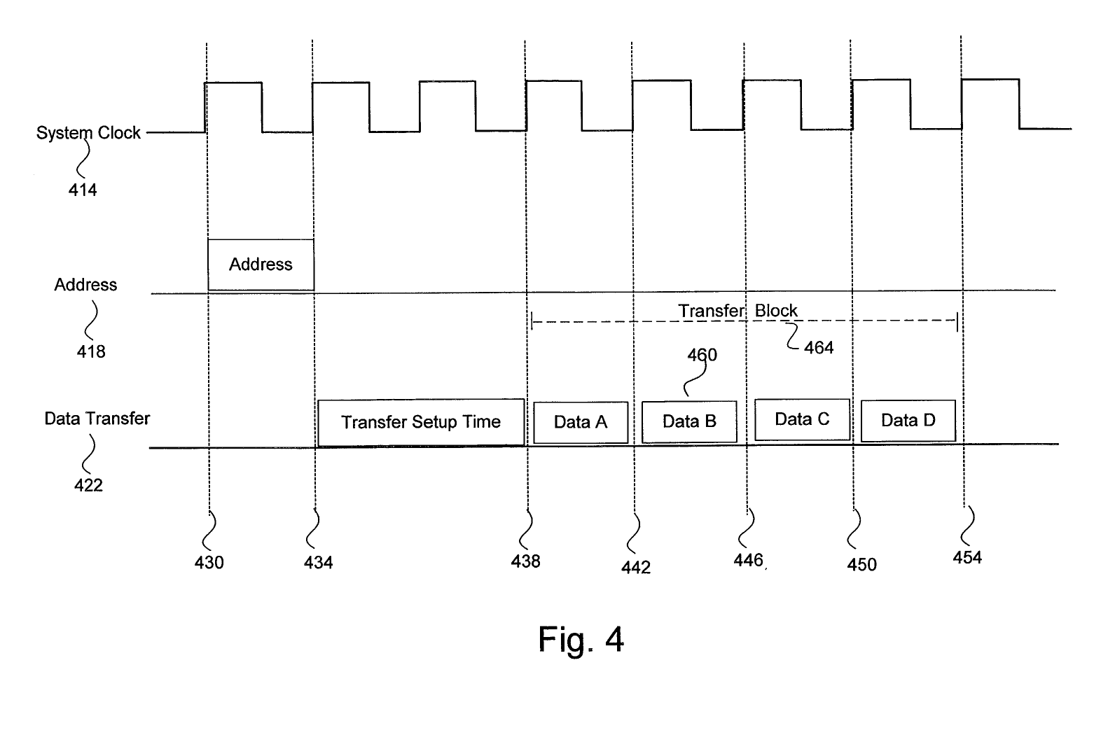

In certain embodiments, memory 126 may be limited to performing efficient block transfer operations to move transfer blocks of data 316 in or out of memory 126. For example, memory may be implemented as a synchronous dynamic random access memory (SDRAM) or other similar block transfer memory device. An exemplary embodiment for performing the foregoing block transfer operations is further discussed below in conjunction with FIG. 4.

Referring now to FIG. 4, an exemplary timing diagram for one embodiment of a block data transfer operation is shown. In the FIG. 4 embodiment, the timing diagram includes a system clock 414, an address line 418, and a data transfer sequence 422. In alternate embodiments, block data transfer operations may readily include various other timings, elements or functionalities in addition to, or instead of, those timings, elements or functionalities discussed in conjunction with the FIG. 4 embodiment.

In the FIG. 4 embodiment, a data transfer timing cycle may begin at time 430 in response to a rising edge of system clock 414. A data address 418 for a block data transfer operation may also be provided to memory 126 during the initial data transfer timing cycle between time 430 and time 434. At time 434, at the beginning of a second timing cycle, memory 126 may begin to perform a transfer setup procedure that may extend for two timing cycles to end at time 438. In alternate embodiments, the foregoing transfer setup procedure may require various other time periods to complete.

Then, during the four timing cycles between time 438 and time 454, memory 126 may perform a block transfer operation in a single burst to thereby transfer four contiguous segments of data (data A, data B, data C, and data D) as a single transfer block 464. In alternate embodiments, transfer block 464 may readily include any number of combined data segments, and is not restricted in number to the four segments discussed in conjunction with the FIG. 4 embodiment.

From the foregoing discussion, it is apparent that, in certain embodiments, memory 126 may be designed to perform the foregoing block transfer operation. However, due to the transfer setup procedure required and the relatively large size of transfer block 464, repeatedly accessing memory 126 to obtain small amounts of data may become excessively inefficient due to a corresponding consumption of data transfer resources in electronic system 110. For example, repeatedly performing the foregoing block transfer operation (which by definition accesses a transfer block 464 of multiple segments of data) in order to obtain several bits of information from data B 460 may likely result in significant degradation of operational performance in electronic system 110. The present invention therefore provides improved techniques for effectively avoiding the foregoing block data transfer penalty and related operational inefficiencies during certain steps of a DMA data transfer operation.

Referring now to FIG. 5, a block diagram for one embodiment of the FIG. 3 DMA structure 312 is shown, in accordance with the present invention. In the FIG. 5 embodiment, DMA structure 312 may preferably include, but is not limited to, a command structure 1 (512(a)) through a command structure N (512(c)). In alternate embodiments, DMA structure 312 may readily include various other elements or functionalities in addition to, or instead of, those elements or functionalities discussed in conjunction with the FIG. 5 embodiment. Furthermore, in various embodiments, command structures 512 of DMA structure 312 may be stored in memory 126 in either a contiguous or a non-contiguous manner.

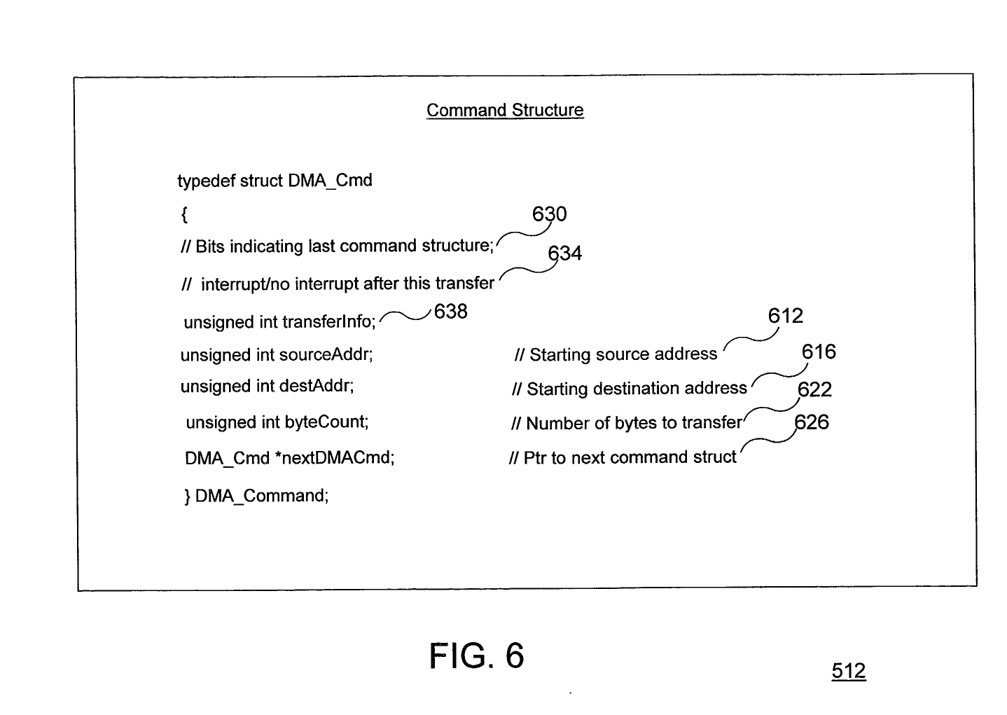

In the FIG. 5 embodiment, DMA structure 312 may preferably include, but is not limited to, a command structure 1 (512(a)) through a command structure N (512(c)) that may, in certain instances form a linked list. In an alternate embodiment, DMA structure 312 may be implemented with only a single command structure 512. In accordance with the present invention, the command structures 512 of DMA structure 312 may therefore advantageously be linked together in manner that allows them to be utilized consecutively without intervention by CPU 114. One embodiment for the configuration and implementation of command structures 512 is further discussed below in conjunction with FIG. 6.

Referring now to FIG. 6, a block diagram for one embodiment of a command structure 512 from FIG. 5 is shown, in accordance with the present invention. In the FIG. 6 embodiment, the configuration of command structure 512 is presented using the C programming language to define one exemplary DMA command structure for DMA data transfer operations in electronic system 110.

In the FIG. 6 embodiment, command structure 512 may preferable include, but is not limited to, a starting source address 612 that corresponds to a source device of a DMA data transfer operation, and a starting destination address 616 that corresponds to a destination device of a DMA data transfer operation. Command structure 512 may also include a transfer bytes total (number of bytes to transfer) 622 that indicates the total size of a corresponding DMA data transfer. DMA engine 216 or other appropriate entity may thus determine when a particular DMA transfer operation is complete by calculating and comparing a current total data-transferred value to the foregoing transfer bytes total 622. Command structure 512 may also preferably include a pointer to next command structure 626 to thereby link any desired command structures 512 in DMA structure 312 into a particular sequence.

In addition, command structure 512 may preferably include a transfer info field (unsigned int transferinfo) 636 which may be utilized for instructing DMA engine 216 to inform CPU 114 whenever a particular DMA transfer operation has completed. In the FIG. 6 embodiment, transfer info field 636 may preferably include a last command structure field (bits indicating a last command structure) 630 to indicate a final command structure in a linked list, and an interrupt/no interrupt after this transfer field 634 to designate whether an interrupt should occur following the current DMA transfer. In alternate embodiments, command structures 512 may readily include various other elements or functionalities in addition to, or instead of, those elements or functionalities discussed in conjunction with the FIG. 6 embodiment.

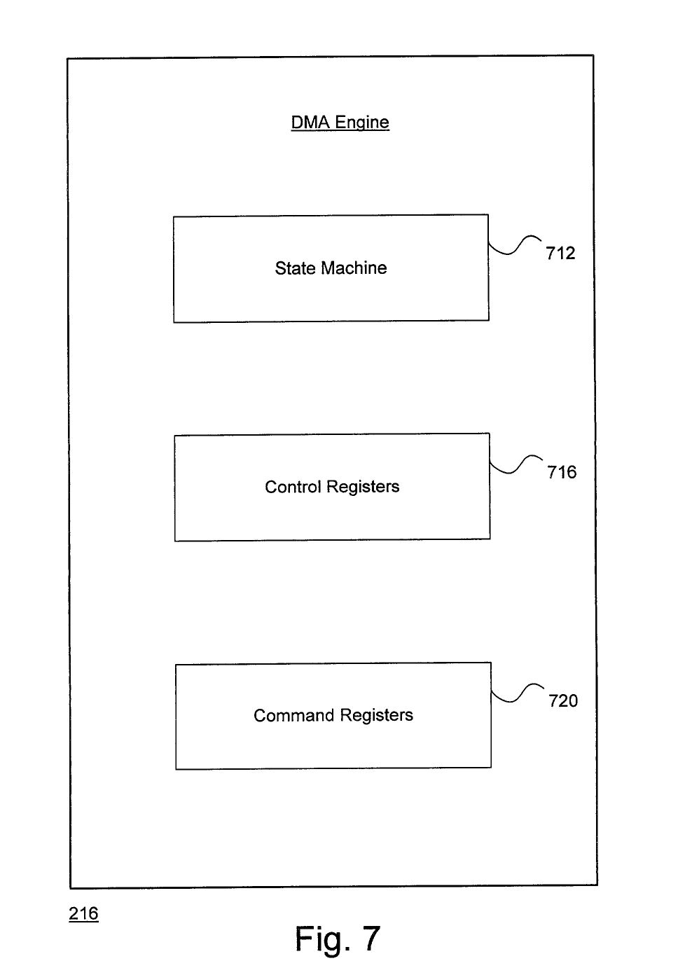

Referring now to FIG. 7, a block diagram of the FIG. 2 DMA engine 216 is shown, in accordance with one embodiment of the present invention. In the FIG. 7 embodiment, DMA engine may be implemented as a transfer engine that preferably includes, but is not limited to, a state machine 712, one or more control registers 716, and one or more command registers 720. In alternate embodiments, DMA engine 216 may readily include various other elements or functionalities in addition to, or instead of, those elements or functionalities discussed in conjunction with the FIG. 7 embodiment.

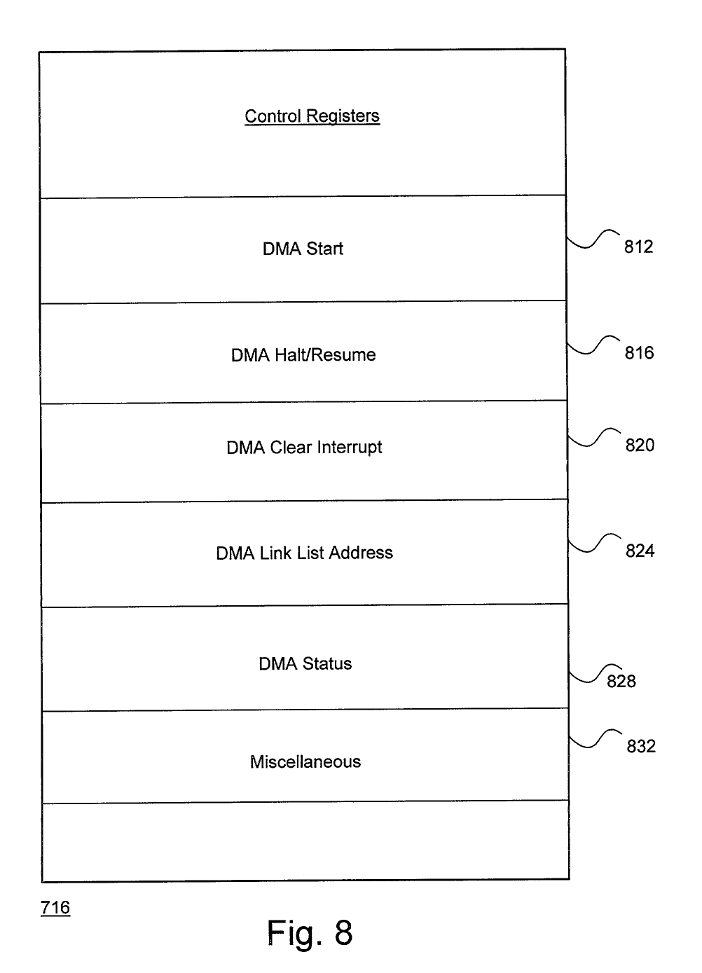

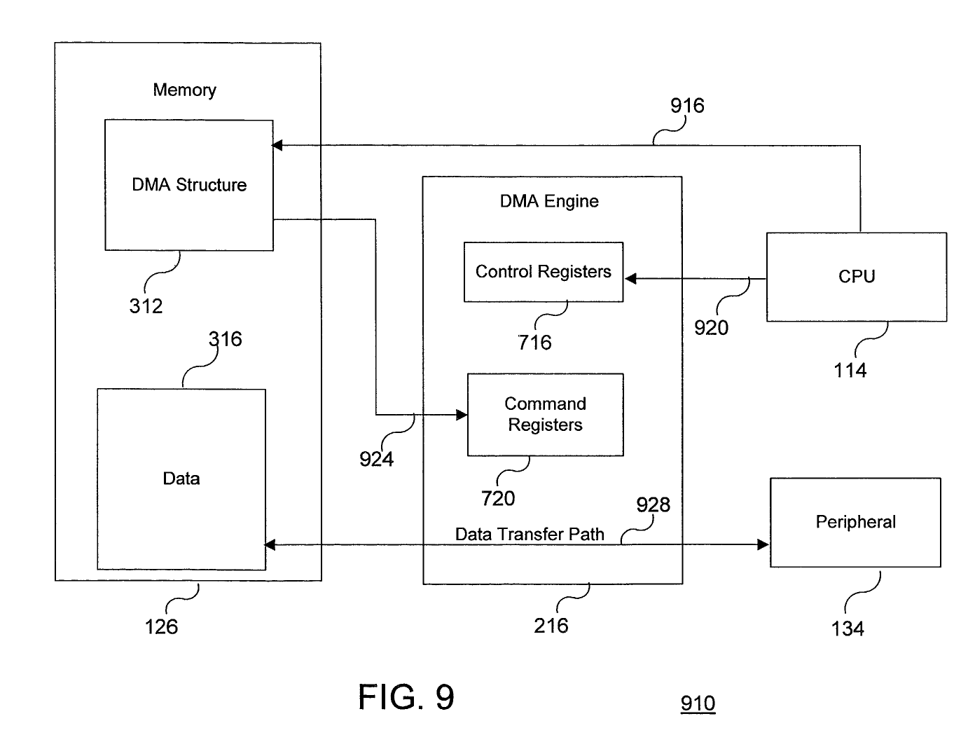

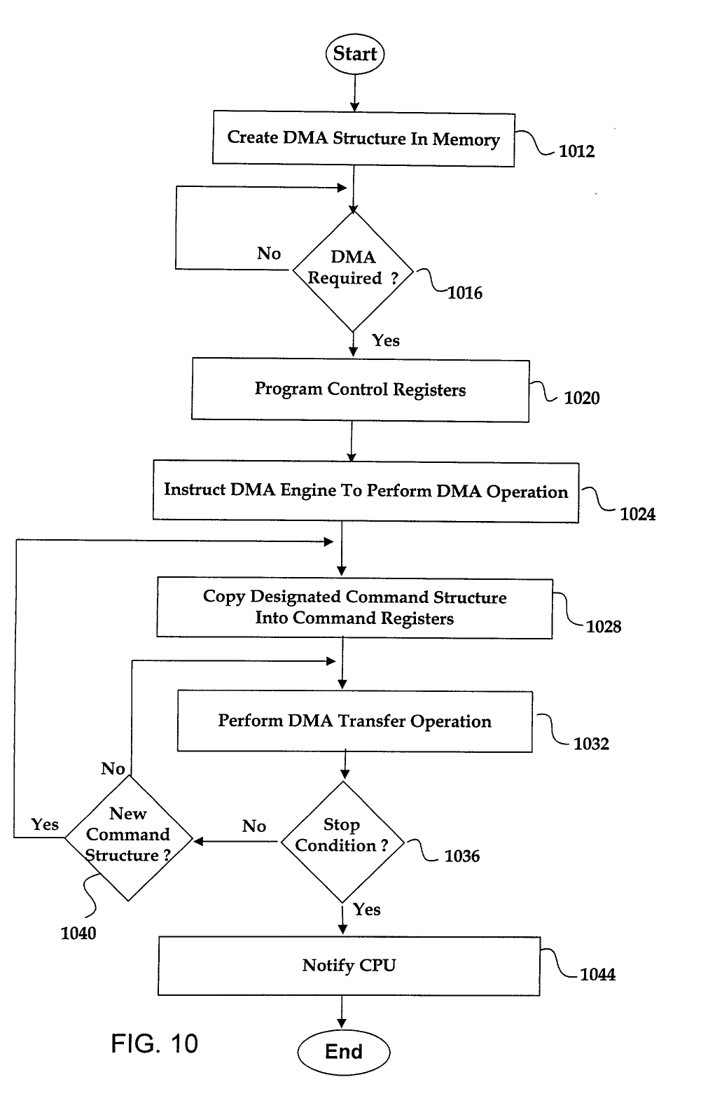

In the FIG. 7 embodiment, state machine 712 may include any appropriate and effective means for controlling the operation of DMA engine 216 to thereby perform various DMA data transfer operations. Control registers 716 may preferably include selected information that DMA engine may repeatedly require for performing various DMA data transfer operations. One embodiment for control registers 716 is discussed below in conjunction with FIG. 8. Command registers 720 may preferably include information from one or more command structures 512 that may be copied into command registers 720 for local access by DMA engine 216 to perform corresponding DMA transfer operations. The functionality and utilization of DMA engine 216 is further discussed below in conjunction with FIGS. 9 and 10.

Referring now to FIG. 8, a block diagram for one embodiment of the FIG. 7 control registers 716 is shown, in accordance with the present invention. In the FIG. 8 embodiment, control registers 716 may preferably include, but are not limited to, a DMA start register 812, a DMA halt/resume register 816, a DMA clear interrupt register 820, a DMA link list address register 824, a DMA status register 828, and one or more miscellaneous registers 832.

In the FIG. 8 embodiment, CPU 114 or other appropriate entities may preferably set a start bit in DMA start register 812 to initiate a DMA data transfer operation. In one embodiment, DMA start register 812 may preferably be implemented as a 1-byte register. CPU 114 or other appropriate entities may preferably set a halt bit in DMA halt/resume register 816 to halt a particular DMA data transfer operation. Similarly, CPU 114 or another entity may reset the foregoing halt bit in the DMA halt/resume register 816 to resume the particular DMA data transfer operation. In one embodiment, DMA halt/resume register 816 may preferably be implemented as a 1-byte register.

In the FIG. 8 embodiment, CPU 114 or another entity may set a designated bit in DMA clear interrupt register 820 to thereby clear a particular DMA interrupt event. In one embodiment, DMA clear interrupt register 820 may preferably be implemented as a 1-byte register. CPU 114 or another appropriate entity may preferably program DMA link list address register 824 to indicate the physical address in memory 126 of the first command structure 512 for a particular DMA data transfer operation. In one embodiment, DMA link list address register 824 may be implemented as a 4-byte register.

In the FIG. 8 embodiment, DMA status register 828 may include various bits indicating one or more status conditions that correspond to a current DMA data transfer operation. DMA engine 216 or another appropriate entity may preferably write to DMA status register 828 to periodically update any stored status conditions. DMA status registers 828 may therefore be read by CPU 114 or any other interested entity to determine the foregoing one or more status conditions corresponding to a current DMA data transfer operation. In one embodiment, DMA status register 828 may preferably be implemented as a 1-byte register. One or more miscellaneous registers 832 may include any appropriate or desired information to enable DMA engine 216 to effectively perform DMA data transfer operations. In alternate embodiments, control registers 716 may readily include various other elements or functionalities in addition to, or instead of, those elements or functionalities discussed in conjunction with the FIG. 8 embodiment.

Referring now to FIG. 9, a block diagram illustrating a data transfer operation 910 is shown, in accordance with one embodiment of the present invention. In the FIG. 9 embodiment, data transfer operation 910 may preferably utilize, but is not limited to, a CPU 114, a DMA engine 216 with control registers 716 and command registers 720, a memory 126 with a DMA structure 312 and data 316, and a peripheral 134. In alternate embodiments, data transfer operation 910 may readily function with various other elements or functionalities in addition to, or instead of, those elements or functionalities discussed in conjunction with the FIG. 9 embodiment.

In the FIG. 9 embodiment, initially, CPU 114 may preferably create one or more appropriate command structures 512 in DMA structure 312 of memory 126 via path 916. CPU 114 may subsequently determine that a particular DMA operation is required in electronic system 110, and may responsively program control registers 716 in DMA engine 216 via path 920 to thereby initiate the required DMA operation. CPU 114 may then advantageously relinquish control of the DMA operation to DMA engine 216, and begin efficiently performing other processing tasks for electronic system 110.

In response, state machine 712 (not shown) of DMA engine 216 may preferably transfer one or more appropriate command structures 512 from DMA structure 312 in memory 126 into command registers 720 of DMA engine 216 via path 924. State machine 712 of DMA engine 216 may then locally access relevant information from control registers 716 and command registers 720 to thereby perform a DMA data transfer operation between a designated peripheral 134 and memory 126 via data transfer path 928.

In accordance with the present invention, CPU 114 may advantageously program control registers 716 with selected information that CPU 114, DMA engine, or other interested entities may repeatedly require during a DMA data transfer procedure, in order to avoid the significant block transfer penalty and other related operational inefficiencies, as discussed above in conjunction with FIG. 4.

The present invention thus advantageously conserves system resources by effectively minimizing the number of accesses by CPU 114 to various DMA registers. The present invention also beneficially conserves system resources by efficiently minimizing the number of accesses by DMA engine 216 to memory 126 in order to update various types of stored information, such as status information for a current DMA operation.

Referring now to FIG. 10, a flowchart of method steps for performing a data transfer operation is shown, in accordance with one embodiment of the present invention. The FIG. 10 embodiment is presented for purposes of illustration, and in alternate embodiments, the present invention may readily utilize various steps and sequences other than those discussed in conjunction with the FIG. 10 embodiment.

In the FIG. 10 embodiment, initially, in step 1012, CPU 114 may preferably create a DMA structure 312 that includes one or more command structures 512, and store the resultant DMA structure 312 into memory 126. Then, in step 1016, CPU 114 may preferably monitor electronic system 110 until performance of a DMA transfer operation is required. When a DMA transfer operation is required in electronic system 110, then, in step 1020, CPU 114 may preferably program control registers 716 of DMA engine 216 to provide relevant information regarding the required DMA transfer operation for local access by DMA engine 216.

Next, in step 1024, CPU 114 may preferably instruct DMA engine 216 to perform the required DMA operation. In certain embodiments, CPU 114 may set a start bit in a DMA start register 812 of control registers 716 to thereby instruct DMA engine 216 to perform the required DMA operation. In response, in step 1028, state machine 712 of DMA engine 216 may preferably copy a designated command structure 512 from DMA structure 312 of memory 126 into command registers 720 of DMA engine 216.

In step 1032, DMA engine 216 may then preferably reference the information in control registers 716 and command registers 720 to effectively perform the required DMA transfer operation. In step 1036, DMA engine 216 may preferably determine whether a stop condition has occurred with regard to the current DMA transfer operation. If no stop condition has occurred, then in step 1040, DMA engine 216 may preferably determine whether a new command structure 512 may be required for continuation of the current DMA transfer operation.

If a new command structure 512 is required, then the FIG. 10 process returns to step 1028, where state machine 712 of DMA engine 216 may preferably copy a new designated command structure 512 from DMA structure 312 of memory 126 into command registers 720 of DMA engine 216. As previously discussed, DMA engine 216 may then preferably reference the information in control registers 716 and command registers 720 to continue effectively performing the required DMA transfer operation. In foregoing step 1040, if no new command structure 512 is required, then the FIG. 10 process may return to step 1032 to continue performing the current DMA transfer operation.

However, in foregoing step 1036, if DMA engine 216 determines that a stop condition has occurred with regard to the current DMA transfer operation, then, in step 1044, DMA engine 216 may preferably notify CPU 114 regarding the occurrence of the foregoing stop condition, and the FIG. 10 process may then terminate.

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. An apparatus for transferring data in an electronic system, comprising:
a DMA engine configured to perform a data transfer operation for transferring said data between a peripheral device and a memory device; and
a processor coupled to said DMA engine for creating a DMA structure in said memory device for subsequent access by said DMA engine, said processor also selectively programming control registers of said DMA engine to thereby facilitate efficiently performing said data transfer operation.

2. The apparatus of claim 1 wherein said data transfer operation includes a direct memory access data transfer operation.

3. The apparatus of claim 1 wherein said memory device is implemented as a synchronous dynamic random-access memory device that is optimized for performing block data transfer operations.

4. The apparatus of claim 1 wherein said electronic system is implemented as one of an audio/visual electronic device, a consumer electronics device, a portable electronics device, and a computer device.

5. The apparatus of claim 1 wherein said electronic system includes a bridge device that facilitates bi-directional communications between said processor, said peripheral device, and said memory device.

6. The apparatus of claim 5 wherein said bridge device includes a processor interface for communicating with said processor, a memory interface for communicating with said memory device, a peripheral interface for communicating with said peripheral device.

7. The apparatus of claim 1 wherein said peripheral device is implemented as one of an integrated circuit device and an electronic system.

8. The apparatus of claim 1 wherein said DMA structure includes at least one command structure that has command information for performing said data transfer operation.

9. The apparatus of claim 8 wherein said command structure includes a starting source address, a starting destination address, a transfer-bytes total field, a next command-structure pointer, a last command-structure field, an interrupt/no interrupt after current transfer field, and a transfer-info field.

10. The apparatus of claim 1 wherein said DMA structure includes a series of command structures that are linked together in a linked list to thereby perform a series of direct memory access operations.

11. The apparatus of claim 1 wherein said DMA engine includes a state machine for controlling said data transfer operation, one or more command registers for locally storing one or more command structures from said DMA structure, and said control registers.

12. The apparatus of claim 1 wherein said control registers include a DMA start register that said processor may program to start said data transfer operation, a DMA halt/resume register that said processor may program to halt or resume said data transfer operation, a DMA clear interrupt register that said processor may program to clear an interrupt of said data transfer operation, a DMA link list address register that said processor may program with a physical address in said memory device of a first command structure in said DMA structure, and a DMA status register that said DMA engine may program to indicate a current status of said data transfer operation.

13. The apparatus of claim 1 wherein said processor initially creates said DMA structure in said memory device, said DMA structure including one or more command structures that each include command information for performing a separate DMA data transfer operation, said memory device being optimized to perform block data transfers.

14. The apparatus of claim 13 wherein said processor programs said control registers with DMA data transfer information that is then locally available to said DMA engine for performing said data transfer operation.

15. The apparatus of claim 14 wherein said processor instructs said DMA engine to perform said data transfer operation after programming said control registers, said processor then releasing control of said data transfer operation and performing other system processing tasks for said electronic system.

16. The apparatus of claim 15 wherein said DMA engine copies one or more designated command structures from said DMA structure in said memory device into one or more command registers that are locally coupled to said DMA engine.

17. The apparatus of claim 16 wherein said DMA engine performs said data transfer operation between said peripheral device and said memory device by referring to said control registers and said command registers.

18. The apparatus of claim 17 wherein said DMA engine detects a stop condition while performing said data transfer operation.

19. The apparatus of claim 18 wherein said DMA engine stops said data transfer operation and notifies said processor regarding said stop condition.

20. The apparatus of claim 17 wherein said DMA engine transfers a new linked command structure from said DMA structure into said command registers for performing a linked DMA data transfer operation without an intervention by said processor.

21. A method for transferring data in an electronic system, comprising the steps of:
creating a DMA structure in a memory device for subsequent access by a DMA engine;
programming control registers of said DMA engine with a processor to thereby facilitate efficiently performing a data transfer operation; and
performing said data transfer operation by utilizing said DMA engine to thereby transfer said data between a peripheral device and said memory device.

22. The method of claim 21 wherein said data transfer operation includes a direct memory access data transfer operation.

23. The method of claim 21 wherein said memory device is implemented as a synchronous dynamic random-access memory device that is optimized for performing block data transfer operations.

24. The method of claim 21 wherein said electronic system is implemented as one of an audio/visual electronic device, a consumer electronics device, a portable electronics device, and a computer device.

25. The method of claim 21 wherein said electronic system includes a bridge device that facilitates bi-directional communications between said processor, said peripheral device, and said memory device.

26. The method of claim 25 wherein said bridge device includes a processor interface for communicating with said processor, a memory interface for communicating with said memory device, a peripheral interface for communicating with said peripheral device.

27. The method of claim 21 wherein said peripheral device is implemented as one of an integrated circuit device and an electronic system.

28. The method of claim 21 wherein said DMA structure includes at least one command structure that has command information for performing said data transfer operation.

29. The method of claim 28 wherein said command structure includes a starting source address, a starting destination address, a transfer-bytes total field, a next command-structure pointer, a last command-structure field, an interrupt/no interrupt after current transfer field, and a transfer-info field.

30. The method of claim 21 wherein said DMA structure includes a series of command structures that are linked together in a linked list to thereby perform a series of direct memory access operations.

31. The method of claim 21 wherein said DMA engine includes a state machine for controlling said data transfer operation, one or more command registers for locally storing one or more command structures from said DMA structure, and said control registers.

32. The method of claim 21 wherein said control registers include a DMA start register that said processor may program to start said data transfer operation, a DMA halt/resume register that said processor may program to halt or resume said data transfer operation, a DMA clear interrupt register that said processor may program to clear an interrupt of said data transfer operation, a DMA link list address register that said processor may program with a physical address in said memory device of a first command structure in said DMA structure, and a DMA status register that said DMA engine may program to indicate a current status of said data transfer operation.

33. The method of claim 21 wherein said processor initially creates said DMA structure in said memory device, said DMA structure including one or more command structures that each include command information for performing a separate DMA data transfer operation, said memory device being optimized to perform block data transfers.

34. The method of claim 33 wherein said processor programs said control registers with DMA data transfer information that is then locally available to said DMA engine for performing said data transfer operation.

35. The method of claim 34 wherein said processor instructs said DMA engine to perform said data transfer operation after programming said control registers, said processor then releasing control of said data transfer operation and performing other system processing tasks for said electronic system.

36. The method of claim 35 wherein said DMA engine copies one or more designated command structures from said DMA structure in said memory device into one or more command registers that are locally coupled to said DMA engine.

37. The method of claim 36 wherein said DMA engine performs said data transfer operation between said peripheral device and said memory device by referring to said control registers and said command registers.

38. The method of claim 37 wherein said DMA engine detects a stop condition while performing said data transfer operation.

39. The method of claim 38 wherein said DMA engine stops said data transfer operation and notifies said processor regarding said stop condition.

40. The method of claim 37 wherein said DMA engine transfers a new linked command structure from said DMA structure into said command registers for performing a linked DMA data transfer operation without an intervention by said processor.

41. The method of claim 21 wherein said processor selectively programs said control registers of said DMA engine to provide locally-accessible transfer information and thereby avoid a block transfer penalty associated with repeatedly accessing relatively small amounts of DMA transfer information from said memory device, said processor creating said DMA structure in said memory device to thereby provide an effective storage medium for storing a linked list of multiple command structures.

42. An apparatus for transferring data in an electronic system, comprising:
means for creating a DMA structure in a memory device for subsequent access by a DMA engine;
means for programming control registers of said DMA engine to thereby facilitate efficiently performing a data transfer operation; and
means for performing said data transfer operation to thereby transfer said data between a peripheral device and said memory device.

43. A method for performing a DMA data transfer procedure in an electronic system, comprising the steps of:
creating a DMA structure in a block transfer memory by utilizing a central processing unit, said DMA structure including a linked-list of command structures that each include command information for performing said DMA data transfer procedure;
programming one or more local control registers of a DMA engine with said central processing unit in response to a DMA data transfer requirement, said local control registers including a DMA start register and at least one of a DMA halt/resume register, a DMA clear interrupt register, a DMA link list address register, and a DMA status register;
copying at least one of said command structures from said block transfer memory into one or more local command registers that are coupled to said DMA engine;
performing said DMA data transfer operation with said DMA engine by referencing said local control registers and said local command registers;
detecting a stop condition corresponding to said DMA data transfer operation;
stopping said DMA data transfer operation by utilizing said DMA engine; and
notifying said central processing unit regarding said stop condition of said DMA data transfer operation.
